(19) United States
(12) Patent Application Publication
(10) Pub. No.: US 2023/0326642 A1
(43) Pub. Date: Oct. 12, 2023

(54) MAGNET WITH BOND COATING AND MAGNETIC COMPONENT

(71) Applicants: TIANJIN SANHUAN LUCKY NEW MATERIAL CO.,LTD., Tianjin (CN); BEIJING ZHONG KE SAN HUAN HI-TECH CO., LTD., Beijing (CN)

(72) Inventors: Xiaogang BAI, Tianjin (CN); Haihua YU, Tianjin (CN); Guanghui PAN, Tianjin (CN); Xue HAN, Tianjin (CN)

(21) Appl. No.: 18/335,597

(22) Filed: Jun. 15, 2023

Related U.S. Application Data
(63) Continuation of application No. PCT/CN2021/126403, filed on Oct. 26, 2021.

(30) Foreign Application Priority Data
Dec. 29, 2020 (CN) 202011600678.5

(51) Int. Cl. H01F 7/02; H01F 41/02

(52) U.S. Cl. CPC H01F 7/021; H01F 41/0253

(57) ABSTRACT

A magnet includes a magnet matrix and a bond coating arranged at a surface of the magnet matrix. The bond coating includes a thermosetting adhesive layer and a thermoplastic adhesive layer. The thermosetting adhesive layer includes a foaming agent. The thermosetting adhesive layer and the thermoplastic adhesive layer are arranged in sequence from the surface of the magnet matrix to outside.

### CROSS-REFERENCE TO RELATED APPLICATIONS

This application is a continuation of International Application No. PCT/CN2021/126403, filed Oct. 26, 2021, which claims priority to Chinese Application No. 202011600678.5, filed Dec. 29, 2020, the entire contents of both of which are incorporated herein by reference.

### TECHNICAL FIELD

The present disclosure relates to a magnet with bond coating, a preparation method thereof, and a method of preparing a magnetic component.

### BACKGROUND

Compared with conventional electric excitation motors, permanent magnet motors have the characteristics of simple structure, light weight, small volume, less loss, high efficiency and the like. Therefore, permanent magnet motors are applied widely. Compared to magnet surface-mounted permanent magnet motors, magnet embedded permanent magnet motors have stronger torque density.

A magnet embedded permanent magnet motor is a type of motor that uses liquid adhesive to bond and fix the magnet in the slot of the rotor or stator. Generally, a magnet coated with liquid adhesive is inserted into the slot of the rotor or stator, or a liquid adhesive is applied to the opening of the slot, then a magnet is inserted through the opening of the slot containing the liquid adhesive, thereby applying the liquid adhesive to the surface of the magnet. And then, the rotor or stator is placed at room temperature or in a drying furnace to cure the liquid binder, achieving adhesion between the magnet and the rotor or stator.

However, in the above bonding method, since the liquid adhesive has adhesiveness before curing, during movement of the magnet, it is easy for liquid adhesive to get stuck at the opening or the inner wall of the slot, before the magnet reaches a desired position in the slot. Further, since the liquid adhesive is soft before curing, the adhesive is deformed or partially peeled off from the magnet during the process of entering the slot, resulting in most of the applied liquid adhesive not being able to enter the inside of the slot, further leading to poor adhesion. Besides, there is also a problem of poor operability in timely wiping off scraped or spilled liquid adhesive before curing. In addition, transportation and storage of magnets pre-coated with the liquid adhesive and ensuring that the adhesive does not lose its function are also issues that need to be considered.

Chinese patent publication CN110401277A discloses applying the adhesive containing a foaming agent to the surface of the magnet, and first curing a part of the adhesive through the first heating process to reduce the viscosity of the adhesive surface. At the same time, the foaming agent in the adhesive protrudes on the surface, causing the adhesive to form point contact with the slot, thereby avoiding the problem of accidental deformation or peeling of the adhesive during the process of entering the slot.

In Japanese patent publication JP2007174872A, a foaming sheet is made of a solid resin at room temperature with a foaming agent, and is inserted into the gap between a magnet and a slot and heated, and the foaming sheet expands so that one surface side is bonded to the outer surface of the magnet and the other surface side is bonded to the inner wall surface of the slot. This can suppress the extrusion of resin from the component slot and prevent leakage. Reducing the viscosity of the adhesive or inserting foam sheets which are prepared by adding foaming agent to the adhesive into the gap can solve the problem of poor adhesion of the adhesive. For the method of reducing viscosity, due to its soft adhesive layer, it is not convenient for long-term storage or transportation. For the method of using adhesive and foaming agent to process foam sheets, since corresponding processing needs to be carried out according to different sizes of magnets or slots to increase adaptability, the processing convenience is poor.

### SUMMARY

The present disclosure provides a magnet with bond coating, a preparation method thereof, a method of preparing a magnetic component and a magnetic component, which facilitates the storage, transportation, and adhesion of the magnet to the carrier.

To solve one of the above problems, the first aspect of the disclosure provides a magnet with bond coating comprises a magnet matrix and at least one bond coating,

the first bond coating is arranged at the surface of the magnet matrix;

wherein:
the bond coating comprises a thermosetting adhesive layer, a thermoplastic adhesive layer, and the thermosetting adhesive layer is closer to the surface of the magnet matrix than the thermoplastic adhesive layer; and the thermosetting adhesive layer comprises a foaming agent.

Optionally, the magnet with bond coating further comprises multiple coatings,

wherein:
the multiple coatings are sequentially set outward from the surface of the magnet matrix;
the ratio of the thickness of the outermost thermoplastic adhesive layer to the thickness of any remaining thermoplastic adhesive layer is in a range from 2:1 to 8:1.

Optionally, the total thickness of the bond coatings is in a range from 80 μm to 150 μm.

Optionally, the ratio of the sum of the thicknesses of all thermosetting adhesive layers to the sum of the thicknesses of all thermoplastic adhesive layers is in a range from 4:1 to 10:1.

Optionally, the thermoplastic adhesive layer comprises a first auxiliary agent, which comprises nano barium sulfate and nano ethylene wax.

Optionally, the thermosetting adhesive layer comprises a hardener, a filler, and a second auxiliary agent,

the hardener includes at least one of guanidine, substituted guanidine, aromatic amine or guanamine derivative;

the filler includes at least one of silicon dioxide, calcium oxide, zinc oxide, magnesium oxide, aluminum oxide, calcium carbonate or talcum;

the second auxiliary agent includes at least one of a curing accelerator, a coupling agent, a defoaming agent, fiber, rubber particles, a diluent or a flame retardant.

The second aspect of the present disclosure provides a method for preparing magnet, comprising:
mixing a foaming agent into a thermosetting adhesive to serve as a raw material of the thermosetting adhesive layer;
applying adhesive sequentially outward from the surface of the magnet matrix to obtain at least one bond coating,
wherein:
the bond coating comprises a thermosetting adhesive layer and a thermoplastic adhesive layer, and the thermosetting adhesive layer is closer to the surface of the magnet matrix than the thermoplastic adhesive layer; and
the thermosetting adhesive layer is subjected to low-temperature surface drying treatment, and the thermoplastic adhesive layer is subjected to low-temperature curing treatment.

Optionally, the total thickness of the bond coatings is in a range from 80 μm to 150 μm.

Optionally, applying multiple coatings wherein the ratio of the thickness of the outermost thermoplastic adhesive layer to the thickness of any remaining thermoplastic adhesive layer is in a range from 2:1 to 8:1.

Optionally, the ratio of the sum of the thicknesses of all thermosetting adhesive layers to the sum of the thicknesses of all thermoplastic adhesive layers is in a range from 4:1 to 10:1.

Optionally, mixing a monomer for synthesizing a thermoplastic base agent, an initiator, and a first auxiliary agent in distilled water as raw materials of the thermoplastic adhesive layer before applying process.

Optionally, forming single layer of thermosetting adhesive layer by applying the raw material of the thermosetting adhesive layer multiple times.

Optionally, proceeding the foaming agent pretreatment by a monomer used for synthesizing the thermoplastic base agent before the mixing process; and mixing the pretreated foaming agent into the thermosetting adhesive as a raw material to form a thermosetting adhesive layer.

The third aspect of the present disclosure provides the magnetic component comprising a magnet with bond coating and a carrier, wherein the heated and expanded bond coating fills between the magnet matrix and the carrier.

The forth aspect of the present disclosure provides a method for preparing magnetic component, comprising:
inserting the magnet with bond coating into the slot of the carrier;
heating the carrier loaded with the magnet, the foaming agent contained in the bond coating expands, thermosetting adhesive layer cross-links and cures, the thermosetting adhesive layer and the thermoplastic adhesive layer co-polymerize, and the heated bond coating fills the gap between the magnet matrix and walls of the slot of the carrier.

The advantages of the present disclosure will be set forth.

The magnet with bond coating is easy to store and transport due to the low-temperature surface drying treatment of the thermosetting adhesive and the low-temperature curing treatment of the thermoplastic adhesive; and even after long-term storage, the foaming agent still maintains its original expansion ability. Since the thermosetting adhesive layer is processed by low temperature surface drying and the thermoplastic adhesive layer is processed by low temperature curing, when the soft adhesive is inserted into the holding slot of the carrier, the deformation or uneven distribution of the adhesive can be avoided. The bonding of the magnet to the carrier is facilitated.

### BRIEF DESCRIPTION OF THE DRAWING

FIG. 1 is a first schematic diagram of the magnet with bond coating of the present disclosure;

FIG. 2 is a second schematic diagram of the magnet with bond coating of the present disclosure.

### DETAILED DESCRIPTION OF EMBODIMENTS

The technical solutions of the present disclosure are described below clearly and completely with reference to the drawings in the embodiments of the present disclosure, and it is obvious that the described embodiments are some, not all, of the embodiments of the present disclosure. All other embodiments obtained by a person skilled in the art based on the embodiments in the present disclosure without making any creative effort belong to the protection scope of the present disclosure.

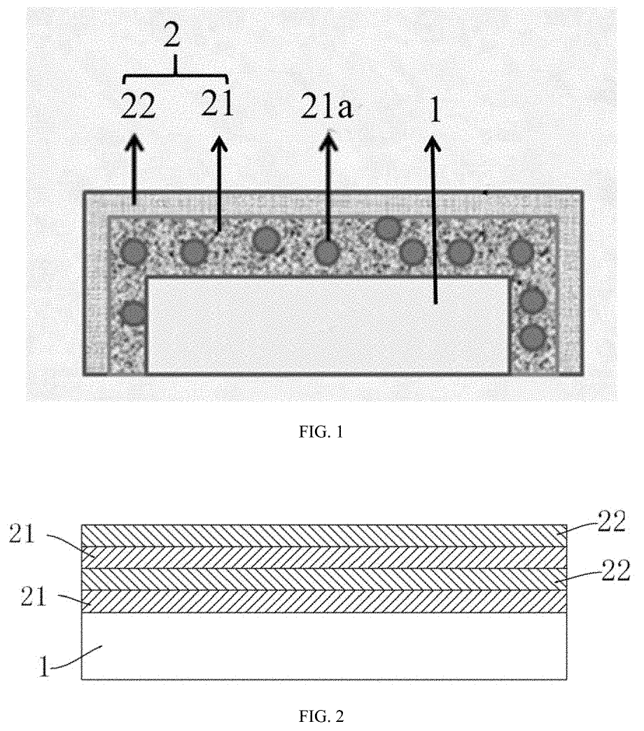

As shown in FIGS. 1 and 2, the present disclosure provides a magnet with bond coating. The magnet includes a magnet matrix 1 and a bond coating 2. The magnet matrix 1 is prepared from magnetic material, such as neodymium-iron-boron magnet.

Each bond coating 2 comprises a thermosetting adhesive layer 21 and a thermoplastic adhesive layer 22. The thermosetting adhesive layer 21 mainly contains a thermosetting adhesive which can be cured at a certain temperature and a foaming agent 21a which can expands at a certain temperature. The thermoplastic adhesive layer 22 contains a thermoplastic adhesive which can cure at low temperature. In each of the bond coating 2, the thermosetting adhesive layer 21 is closer to the surface of the magnet matrix 1 than the thermoplastic adhesive layer 22.

The number of the bond coating 2 is at least one coating. The first bond coating is set on the surface of the magnet matrix 1. When the number of the bond coating 2 is one, the first bond coating is the entire bond coating, the thermosetting adhesive layer 21 is applied to the surface of the magnet matrix 1, and the thermoplastic adhesive layer 22 is applied to the surface of the thermosetting adhesive layer 21, which constitutes the magnet with bond coating.

The magnet with bond coating is sequentially provided with at least one bond coating from the surface of the magnet matrix outwards. The thermoplastic adhesive layer can cure at the temperature range from 40° C. to 90° C. to form a thin layer without adhesion, which protect the thermosetting adhesive layer, so the magnet is easy to store and transport at room temperature. When the magnet with bond coating is heated at the temperature range from 150° C. to 200° C., the thermoplastic adhesive layer of the bond coating becomes soft, the foaming agent in the uncured thermosetting adhesive layer expands. The gradually expanding thermosetting adhesive layer will break through the thermoplastic adhesive layer, and then wrap around the already broken thermoplastic adhesive layer. Besides, the thermosetting adhesive not only self-crosslinks and cures, but also blends and copolymerizes with the thermoplastic adhesive to form a stable cross-linking structure at the temperature range from 150° C. to 200° C.

Optionally, the magnet with bond coating further comprises multiple coatings, the multiple bond coatings 2 are sequentially set outward from the surface of the magnet matrix 1. The multiple bond coatings refers to two or more coatings.

The multiple bond coatings 2 are sequentially arranged outward from the surface of the magnet matrix 1, that is, the thermosetting adhesive layer 21 and the thermoplastic adhesive layer 22 are alternately arranged outward from the surface of the magnet matrix 1. So the application process of the bond coating is to apply a thermosetting adhesive layer 21, then a thermoplastic adhesive layer 22 is applied, and then another thermosetting adhesive layer 21 is applied, followed by a thermoplastic adhesive layer 22, and so on

As shown in FIG. 2, the number of the bond coatings 2 is two, wherein the first thermosetting adhesive layer 21 is located on the surface of the magnet matrix 1, the first thermoplastic adhesive layer 22 is located above the first thermosetting adhesive layer 21, the second thermosetting adhesive layer 21 is located above the first thermoplastic adhesive layer 22, and the second thermoplastic adhesive layer 22 is located above the second thermosetting adhesive layer 21.

When the magnet with bond coating further comprises multiple coatings, that is, when both the thermosetting adhesive layer and the thermoplastic adhesive layer are multiple layers, the thickness of the thermosetting adhesive layers of each layer is equal. Except for the outermost thermoplastic adhesive layer, the thickness of the other thermoplastic adhesive layers is equal. The thickness ratio of the outermost thermoplastic adhesive layer to any other layer's thermoplastic adhesive layer is in a range from 2:1 to 8:1. For example, if the thermosetting adhesive layer consists of two layers and the thermoplastic adhesive layer consists of two layers, counting outward from the surface of the magnet matrix, the thickness of the second layer of thermoplastic adhesive layer is in a range from 2 to 8 times that of the first layer of thermoplastic adhesive layer. Increasing the thickness of the outermost thermoplastic adhesive layer facilitates the protection of each internal bond coating.

Optionally, the thickness of the bond coating is matched to the mounting design. The total thickness of the bond coatings is in a range from 80 μm to 150 μm, so that the bond coating can meet the requirements of adhesive performance while avoiding waste of adhesive.

Optionally, the ratio of the sum of the thicknesses of all thermosetting adhesive layers to the sum of the thicknesses of all thermoplastic adhesive layers is in a range from 4:1 to 10:1.

Optionally, the thermoplastic adhesive used to form the thermoplastic adhesive layer comprises a thermoplastic base agent. The thermoplastic base agent can be acrylic resin, whose monomeris prepared by acrylic acid and its derivatives. Wherein the acrylic acid derivatives are polyurethane modified ethyl methacrylate, polyurethane modified methyl methacrylate, polyurethane modified ethyl acrylate, n-butyl acrylate, hexyl methacrylate, hydroxyethyl acrylate, hydroxymethyl acrylate, etc. The initiators used for synthesizing the acrylic resin include benzoyl peroxide, tert-amyl peroxy-2-ethylhexanoate, tert-amyl peroxybenzoate, etc.

In addition to the thermoplastic base agent, the thermoplastic adhesive also comprises a first auxiliary agent, which includes nano barium sulfate and nano ethylene wax. Wherein, the nano barium sulfate can improve the hardness of the thermoplastic adhesive layer, the nano ethylene wax can improve the smoothness and the anti-sticking property of the thermoplastic adhesive layer, and can also improve the dispersion of the nano barium sulfate in the thermoplastic adhesive layer.

Optionally, the thermoplastic adhesive comprises the following raw materials in a proportion of: 20-30 wt % (mass ratio) of acrylic acid, 20-30 wt % (mass ratio) of acrylic acid derivative, 5-18 wt % of initiator, 0.5-1 wt % (mass ratio) of nano barium sulfate, 0.5-1 wt % of nano ethylene wax and the balance of distilled water. The composition and the ratio of the thermoplastic adhesive can be appropriately adjusted as necessary.

Optionally, the thermosetting adhesive used to form the thermosetting adhesive layer comprises a thermosetting base agent. The thermosetting base agent can be thermosetting resin, such as epoxy resin, phenolic resin, unsaturated polyester resin, silicone resin, modified acrylic resin, etc. The thermosetting adhesive layer may contain multiple resins. Epoxy resins are preferred, and epoxy resins can be cyclic, aliphatic, alicylic, or aromatic. Suitable epoxy resins include preferably bisphenol A epoxy resins, bisphenol F epoxy resins, bisphenol S epoxy resins, phenol formaldehyde epoxy resins, and aromatic epoxy resins (such as epoxy resin containing naphthalene skeleton).

The foaming agent can adopt a physical foaming agent or a chemical foaming agent, wherein the preferable physical foaming agent is expandable hollow microsphere. The expandable hollow microsphere can be composed of a shell composed of a thermoplastic material and a low boiling hydrocarbon encapsulated in the shell. Further, the shell material of the foaming agent is the same as the monomer of the thermoplastic base agent in the raw material of the synthetic thermoplastic adhesive layer. Preferred chemical foaming agents may be expandable graphite, ammonium polyphosphate, azodicarbonamide, and N-aminoethyl piperazine (ATP) adsorbed on nano-silica.

In addition to the monomer for synthesizing a thermosetting base agent, the thermosetting adhesive also comprises a hardener, a filler and a second auxiliary agent.

The hardener includes at least one of guanidine, substituted guanidine, aromatic amine or guanamine derivative. The hardener may participate in the curing reaction according to the chemical calculation and may be catalytically active. The substituted guanidine can be selected from the group consisting of methylguanidine, dimethylguanidine, trimethylguanidine, tetramethylguanidine, dimethylisobiguanidine, tetramethylisobiguanidine, cyanoguanidine, preferably cyanoguanidine.

The filler includes at least one of silicon dioxide, calcium oxide, zinc oxide, magnesium oxide, aluminum oxide, calcium carbonate or talcum.

The second auxiliary agent includes at least one of a curing accelerator, a coupling agent, a defoaming agent, fibers, rubber particles, a diluent or a flame retardant. The curing accelerator can use imidazole derivatives (such as 2-ethyl-2-methylimidazole, N-butylimidazole) or tertiary amines (such as 2-dimethylaminoethanol, N-substituted piperazine). The rubber can be selected as nitrile rubber particles to further reduce the risk of cracking in the bond coating. The fibers can be selected from: carbon fiber, metal fiber, glass fiber, polyester fiber, etc., which can increase the strength and toughness of the bond coating.

The raw materials for synthesizing the thermosetting adhesive layer comprises: 70-80 wt % of the thermosetting base agent, 1-5 wt % of foaming agent, 1-3 wt % of hardener, 2-6 wt % of fillers and the balance of second auxiliary agent. The expansion ratio of the bond coating can be adjusted by adjusting the content of the foaming agent.

Optionally, a suitable amount of solvent may be added to the thermosetting adhesive. The solvent can include acetone, methyl ethyl ketone, toluene, benzene, cyclohexanone, etc.

The present disclosure also provides a method for preparing the magnet with bond coating, comprising:
mixing a foaming agent into a thermosetting adhesive to serve as a raw material of the thermosetting adhesive layer;
applying adhesive sequentially outward from the surface of the magnet matrix to obtain at least one bond coating applying,
wherein the bond coating comprises a thermosetting adhesive layer and a thermoplastic adhesive layer, and the thermosetting adhesive layer is closer to the surface of the magnet matrix than the thermoplastic adhesive layer;
The thermosetting adhesive layer is subjected to low-temperature surface drying treatment, and the thermoplastic adhesive layer is subjected to low-temperature curing treatment.

Each bond coating is formed by applying a thermosetting adhesive layer and a thermoplastic adhesive layer. The magnet with bond coating comprises multiple coatings or single coating.

When the number of the bond coatings is one, a thermosetting adhesive layer is applied to the surface of the magnet matrix, and then a thermoplastic adhesive layer is applied to the surface of the thermosetting adhesive layer to form a bond coating.

When the magnet with bond coating comprises multiple coatings, a thermosetting adhesive layer and a thermoplastic adhesive layer are alternately applied outward from the surface of the magnet matrix, forming multiple bond coatings. By alternately applying multiple thermosetting adhesive layers and multiple thermoplastic adhesive layers, the compatibility of the thermosetting adhesive layers with the thermoplastic adhesive layers can be improved, and the adhesive strength of the bond coating can be improved.

The thermosetting adhesive layer is subjected to low-temperature surface drying treatment. The low-temperature surface drying treatment refers to drying the surface of the thermosetting adhesive layer at the temperature range from 40° C. to 90° C. to facilitate the application of the thermoplastic adhesive layer. And the thermoplastic adhesive layer is subjected to low-temperature curing treatment. The low-temperature curing treatment refers to curing the thermoplastic adhesive layer at the temperature range from 40° C. to 90° C.

Optionally, the total thickness of the bond coatings is in a range from 80 μm to 150 μm.

Optionally, when a plurality of the bond coatings are applied in the applying step, the ratio of the thickness of the outermost thermoplastic adhesive layer to the thickness of any remaining thermoplastic adhesive layer is in a range from 2:1 to 8:1.

Optionally, the ratio of the sum of the thicknesses of all thermosetting adhesive layers to the sum of the thicknesses of all thermoplastic adhesive layers is in a range from 4:1 to 10:1, so that the gradually expanding thermosetting adhesive layer will break through the thermoplastic adhesive layer, and then wrap around the already broken thermoplastic adhesive layer.

Optionally, when there is only one layer of thermosetting adhesive layer, the layer can be formed by applying thermosetting adhesive multiple times. Applying thermosetting adhesive multiple times can avoid the problem of excessive thickness caused by a single application, thereby suppressing the influence of a large amount of water vapor or solvents in the thermosetting adhesive layer on the curing process of the thermosetting adhesive layer.

The method comprises the following specific steps of: firstly, applying a layer of raw materials for the thermosetting adhesive layer, carrying out low-temperature surface drying on the raw material of the first layer of thermosetting adhesive layer, then applying a second layer of raw material for thermosetting adhesive layer, carrying out low-temperature surface drying on the raw material of the second layer of thermosetting adhesive layer, and so on until the thickness of the thermosetting adhesive layers reaches a preset value.

Optionally, the applying step is preceded by mixing a monomer for synthesizing a thermoplastic base agent, an initiator, and a first auxiliary agent in distilled water as raw materials of the thermoplastic adhesive layer.

Optionally, before the mixing step, the foaming agent is pre-treated by a monomer used for synthesizing the thermoplastic base agent.

In the case where the foaming agent is a physical expanding agent, if the shell material of the foaming agent is different from the thermoplastic base agent of the thermoplastic adhesive layer, the foaming agent is modified by the monomer of the thermoplastic base agent before the mixing step.

The modification treatment comprises the process which the monomer of the thermoplastic base agent is adopted to carry out the chemical group grafting modification process on the shell material of the foaming agent.

In the case where the foaming agent is a chemical foaming agent, the monomer of the thermoplastic base agent and the foaming agent form an emulsion. The preparation process of the emulsion comprises: mixing the monomer of thermoplastic base agent with foaming agent, and adding conventional emulsifiers, such as monoglyceride, fatty acid ester, etc., to form an emulsion with good dispersion and stability under mechanical agitation.

In the mixing step, the pretreated foaming agent is mixed into a thermosetting adhesive to be used as a raw material for a thermosetting adhesive layer.

The pretreatment of the foaming agent is beneficial to improving the interface compatibility of the thermosetting adhesive and the thermoplastic adhesive.

If the shell material of the foaming agent is the same as the thermoplastic base agent for the synthesizing thermoplastic adhesive layer, the pretreatment step is omitted.

The magnet with bond coating can be stored and/or transported to the bonding place from the coating place firstly, the coating of the adhesive is not carried out at the assembling place for installing the magnet, so that the operation of liquid adhesive at the place for producing the assembly is avoided, further the problem of wetting or pollution caused by improper use of the adhesive is avoided.

The present disclosure also provides a method for preparing magnetic component, which is prepared using a carrier and the magnet with bond coating as described above. The carrier is provided with a slot for the magnet. Optionally, the carrier is a motor rotor or stator. The preparation method comprises the following steps of:
inserting the magnet with bond coating into the slot of the carrier;
heating the carrier loaded with the magnet at the temperature range from 150° C. to 200° C., wherein, the foaming agent contained in the bond coating expands, the thermosetting adhesive contained in the bond coating is cross-linked and cured, at the same time, the thermosetting adhesive and the thermoplastic adhesive can be blended and copolymerized, thus the heated expanded bond coating fills between the magnet matrix and the carrier.

At the temperature range from 150° C. to 200° C., the thermoplastic adhesive layer becomes soft. As the foaming agent expands, the thermosetting adhesive layer will break through the thermoplastic adhesive layer, and then wrap around the already broken thermoplastic adhesive layer. Besides, the thermosetting adhesive not only self-crosslinks and cures, but also blends and copolymerizes with the thermoplastic adhesive to form a stable cross-linking structure at the temperature range from 150° C. to 200° C. Especially, when the magnet is placed in the slot of the carrier, the thermosetting adhesive flows back during expanding when it meets the inner wall of the slot. The phenomenon of the inner thermosetting adhesive wrapping the outer thermoplastic adhesive is more obvious, so that the magnet is firmly connected with the carrier.

In the embodiment, the raw materials of the thermosetting adhesive layer and the thermoplastic adhesive layer comprise the following components in percentage by weight:

TABLE 1
thermosetting adhesive layer raw material (100% by weight)

| | A-1 | A-2 | A-3 | A-4 |
|---|---|---|---|---|
| Bisphenol A epoxy resin | 70 | 70 | 80 | 75 |
| Expandable hollow microsphere | 3 | 5 | — | — |
| ATP | — | — | 5 | 4 |
| Cyanoguanidine | 1 | 1 | 3 | 3 |
| 2-dimethylaminoethanol | 1 | 1 | 1 | — |
| Zinc oxide | 5 | 3 | 5 | 6 |
| Carbon fiber | 10 | 10 | — | 5 |
| Nano nitrile rubber | 10 | 10 | 6 | 7 |

TABLE 2
thermoplastic adhesive layer raw Material (100% by weight)

| | B-1 | B-2 | B-3 | B-4 |
|---|---|---|---|---|
| polyurethane modified ethyl | 20 | 25 | 28 | 20 |
| acrylate | | | | |
| Acrylic Acid | 20 | 20 | 20 | 30 |
| Benzoyl peroxide | 5 | 10 | 15 | 18 |
| Distilled water | 53.5 | 43.2 | 35.5 | 30 |
| Nano barium sulfate | 0.5 | 0.8 | 1 | 1 |
| Nano ethylene wax | 1 | 1 | 0.5 | 1 |

Wherein the shell material of the foaming agent is the same as the thermoplastic base agent.

### Example 1

The method for preparing the magnet and the magnetic component comprises:
mixing the raw material to prepared the thermosetting adhesive A-1 with reference to Table 1, and mixing the raw material to prepared the thermoplastic adhesive B-1 with reference to Table 2;
applying the thermosetting adhesive A-1 on the surface of a magnet matrix, surface drying at 40° C., then applying the thermoplastic adhesive B-1 on the thermosetting adhesive layer, and curing at 40° C. to obtain the magnet with the bond coating, wherein the thickness of the thermosetting adhesive layer is 80 μm, the thickness of the thermoplastic adhesive layer is 20 μm, so the thickness of the bond coating is 100 μm;
inserting the magnet with bond coating into the slot of the carrier;
heating the carrier loaded with the magnet at 150° C., wherein, the foaming agent contained in the bond coating expands, the thermosetting adhesive contained in the bond coating is cross-linked and cured, at the same time, the thermosetting adhesive and the thermoplastic adhesive can be blended and copolymerized.

### Example 2

The method for preparing the magnet and the magnetic component comprises:
mixing the raw material to prepared the thermosetting adhesive A-1 with reference to Table 1, and mixing the raw material to prepared the thermoplastic adhesive B-1 with reference to Table 2;
applying the thermosetting adhesive A-1 on the surface of a magnet matrix, surface drying at 40° C. to obtain the first thermosetting adhesive layer, then applying the thermosetting adhesive A-1 on the surface of the first thermosetting adhesive layer, surface drying at 40° C. to obtain the second thermosetting adhesive layer, then applying the thermoplastic adhesive B-1 on the second thermosetting adhesive layer, and curing at 40° C. to obtain the magnet with the bond coating, wherein the thickness of the first thermosetting adhesive layer and the second thermosetting adhesive layer are both 40 μm, the total thickness of the thermosetting adhesive layer is 80 μm, the thickness of the thermoplastic adhesive layer is 20 μm, so the thickness of the bond coating is 100 μm;
inserting the magnet with bond coating into the slot of the carrier;
heating the carrier loaded with the magnet at 150° C., wherein, the foaming agent contained in the bond coating expands, besides the thermosetting adhesive contained in the bond coating is cross-linked and cured, at the same time, the thermosetting adhesive and the thermoplastic adhesive can be blended and copolymerized.

### Example 3

The method for preparing the magnet and the magnetic component comprises:
mixing the raw material to prepared the thermosetting adhesive A-1 with reference to Table 1, and mixing the raw material to prepared the thermoplastic adhesive B-1 with reference to Table 2;
applying the thermosetting adhesive A-1 on the surface of a magnet matrix, surface drying at 40° C. to obtain the first thermosetting adhesive layer, then applying the thermoplastic adhesive B-1 on the first thermosetting adhesive layer, and curing at 40° C. to obtain the first thermoplastic adhesive layer, then applying the thermosetting adhesive A-1 on the surface of the first thermoplastic adhesive layer, surface drying at 40° C. to obtain the second thermosetting adhesive layer, then applying the thermoplastic adhesive B-1 on the second thermosetting adhesive layer, and curing at 40° C. to obtain the second thermoplastic adhesive layer, further obtain the magnet with the bond coating, wherein the thickness of the first thermosetting adhesive layer and the second thermosetting adhesive layer are both 40 μm, the total thickness of the thermosetting adhesive layer is 80 μm, besides, the thickness of the first thermoplastic adhesive layer is 15 μm, and the thickness of the second thermoplastic adhesive layer is 5 μm, the total thickness of the thermoplastic adhesive layer is 20 μm, so the thickness of the bond coating is 100 μm;
inserting the magnet with bond coating into the slot of the carrier;
heating the carrier loaded with the magnet at 150° C., wherein, the foaming agent contained in the bond coating expands, besides the thermosetting adhesive contained in the bond coating is cross-linked and cured, at the same time, the thermosetting adhesive and the thermoplastic adhesive can be blended and copolymerized.

### Example 4

The method for preparing the magnet and the magnetic component comprises:
mixing the raw material to prepared the thermosetting adhesive A-2 with reference to Table 1, and mixing the raw material to prepared the thermoplastic adhesive B-2 with reference to Table 2;
applying the thermosetting adhesive A-2 on the surface of a magnet matrix, surface drying at 60° C. to obtain the first thermosetting adhesive layer, then applying the thermosetting adhesive A-2 on the surface of the first thermosetting adhesive layer, surface drying at 60° C. to obtain the second thermosetting adhesive layer, then applying the thermoplastic adhesive B-2 on the second thermosetting adhesive layer, and curing at 60° C. to obtain the magnet with the bond coating, wherein the thickness of the first thermosetting adhesive layer and the second thermosetting adhesive layer are both 35 μm, the total thickness of the thermosetting adhesive layer is 70 μm, the thickness of the thermoplastic adhesive layer is 10 μm, so the thickness of the bond coating is 80 μm;
inserting the magnet with bond coating into the slot of the carrier;
heating the carrier loaded with the magnet at 180° C., wherein, the foaming agent contained in the bond coating expands, besides the thermosetting adhesive contained in the bond coating is cross-linked and cured, at the same time, the thermosetting adhesive and the thermoplastic adhesive can be blended and copolymerized.

### Example 5

The method for preparing the magnet and the magnetic component comprises:
mixing the raw material to prepared the thermosetting adhesive A-2 with reference to Table 1, and mixing the raw material to prepared the thermoplastic adhesive B-2 with reference to Table 2;
applying the thermosetting adhesive A-2 on the surface of a magnet matrix, surface drying at 90° C. to obtain the first thermosetting adhesive layer, then applying the thermosetting adhesive A-2 on the surface of the first thermosetting adhesive layer, surface drying at 90° C. to obtain the second thermosetting adhesive layer, then applying the thermoplastic adhesive B-2 on the second thermosetting adhesive layer, and curing at 90° C. to obtain the magnet with the bond coating, wherein the thickness of the first thermosetting adhesive layer and the second thermosetting adhesive layer are both 60 μm, the total thickness of the thermosetting adhesive layer is 120 μm, the thickness of the thermoplastic adhesive layer is 30 μm, so the thickness of the bond coating is 150 μm;
inserting the magnet with bond coating into the slot of the carrier;
heating the carrier loaded with the magnet at 200° C., wherein, the foaming agent contained in the bond coating expands, besides the thermosetting adhesive contained in the bond coating is cross-linked and cured, at the same time, the thermosetting adhesive and the thermoplastic adhesive can be blended and copolymerized.

### Example 6

The method for preparing the magnet and the magnetic component comprises:
mixing the raw material to prepared the thermosetting adhesive A-3 with reference to Table 1, wherein, before the mixing, the polyurethane modified ethyl acrylate, ATP and monoglyceride are mixed in advance to form emulsion under mechanical stirring, and then mixed into thermosetting adhesive, and mixing the raw material to prepared the thermoplastic adhesive B-3 with reference to Table 2;
applying the thermosetting adhesive A-3 on the surface of a magnet matrix, surface drying at 50° C. to obtain the first thermosetting adhesive layer, then applying the thermoplastic adhesive B-3 on the first thermosetting adhesive layer, and curing at 50° C. to obtain the first thermoplastic adhesive layer, then applying the thermosetting adhesive A-3 on the surface of the first thermoplastic adhesive layer, surface drying at 50° C. to obtain the second thermosetting adhesive layer, then applying the thermoplastic adhesive B-3 on the second thermosetting adhesive layer, and curing at 50° C. to obtain the second thermoplastic adhesive layer, further obtain the magnet with the bond coating, wherein the thickness of the first thermosetting adhesive layer and the second thermosetting adhesive layer are both 45 μm, the total thickness of the thermosetting adhesive layer is 90 μm, besides, the thickness of the first thermoplastic adhesive layer is 4 μm, and the thickness of the second thermoplastic adhesive layer is 16 μm, the total thickness of the thermoplastic adhesive layer is 20 μm, so the thickness of the bond coating is 110 μm;
inserting the magnet with bond coating into the slot of the carrier;
heating the carrier loaded with the magnet at 160° C., wherein, the foaming agent contained in the bond coating expands, besides the thermosetting adhesive contained in the bond coating is cross-linked and cured, at the same time, the thermosetting adhesive and the thermoplastic adhesive can be blended and copolymerized.

### Example 7

The method for preparing the magnet and the magnetic component comprises:
mixing the raw material to prepared the thermosetting adhesive A-3 with reference to Table 1, wherein, before the mixing, the polyurethane modified ethyl acrylate, ATP and monoglyceride are mixed in advance to form emulsion under mechanical stirring, and then mixed into thermosetting adhesive, and mixing the raw material to prepared the thermoplastic adhesive B-3 with reference to Table 2;
applying the thermosetting adhesive A-3 on the surface of a magnet matrix, surface drying at 50° C. to obtain the first thermosetting adhesive layer, then applying the thermoplastic adhesive B-3 on the first thermosetting adhesive layer, and curing at 50° C. to obtain the first thermoplastic adhesive layer, then applying the thermosetting adhesive A-3 on the surface of the first thermoplastic adhesive layer, surface drying at 50° C. to obtain the second thermosetting adhesive layer, then applying the thermoplastic adhesive B-3 on the second thermosetting adhesive layer, and curing at 50° C. to obtain the second thermoplastic adhesive layer, then applying the thermosetting adhesive A-3 on the surface of the second thermoplastic adhesive layer, surface drying at 50° C. to obtain the third thermosetting adhesive layer, then applying the thermoplastic adhesive B-3 on the third thermosetting adhesive layer, and curing at 50° C. to obtain the third thermoplastic adhesive layer, further obtain the magnet with the bond coating, wherein the thickness of the first thermosetting adhesive layer, the second thermosetting adhesive layer and the third thermosetting adhesive layer are both 30 μm, the total thickness of the thermosetting adhesive layer is 90 μm, besides, the thickness of the first thermoplastic adhesive layer and the second thermoplastic adhesive layer both are 2 μm, and the thickness of the third thermoplastic adhesive layer is 16 μm, the total thickness of the thermoplastic adhesive layer is 20 μm, so the thickness of the bond coating is 110 μm;
inserting the magnet with bond coating into the slot of the carrier;
heating the carrier loaded with the magnet at 170° C., wherein, the foaming agent contained in the bond coating expands, besides the thermosetting adhesive contained in the bond coating is cross-linked and cured, at the same time, the thermosetting adhesive and the thermoplastic adhesive can be blended and copolymerized.

### Example 8

The method for preparing the magnet and the magnetic component comprises:
mixing the raw material to prepared the thermosetting adhesive A-4 with reference to Table 1, and mixing the raw material to prepared the thermoplastic adhesive B-4 with reference to Table 2;
applying the thermosetting adhesive A-4 on the surface of a magnet matrix, surface drying at 40° C. to obtain the first thermosetting adhesive layer, then applying the thermosetting adhesive A-4 on the surface of the first thermosetting adhesive layer, surface drying at 40° C. to obtain the second thermosetting adhesive layer, then applying the thermoplastic adhesive B-4 on the second thermosetting adhesive layer, and curing at 40° C. to obtain the magnet with the bond coating, wherein the thickness of the first thermosetting adhesive layer and the second thermosetting adhesive layer are both 50 μm, the total thickness of the thermosetting adhesive layer is 100 μm, the thickness of the thermoplastic adhesive layer is 10 μm, so the thickness of the bond coating is 110 μm;
inserting the magnet with bond coating into the slot of the carrier;
heating the carrier loaded with the magnet at 150° C., wherein, the foaming agent contained in the bond coating expands, besides the thermosetting adhesive contained in the bond coating is cross-linked and cured, at the same time, the thermosetting adhesive and the thermoplastic adhesive can be blended and copolymerized.

### Comparative Example 1

The method for preparing the magnet and the magnetic component comprises:
mixing the raw material to prepared the thermoplastic adhesive B-1 with reference to Table 2, and mixing the foaming agent into the thermoplastic adhesive B-1 to obtain the adhesive raw material;
applying the adhesive raw material on the surface of a magnet matrix, curing at 40° C. to obtain the first adhesive layer, then applying the adhesive raw material on the surface of the first adhesive layer, curing at 40° C. to obtain the second adhesive layer, repeating the steps for 5 times to obtain the magnet, the thickness of each adhesive layer is 20 μm, so the total thickness of the adhesive layer is 100 μm.
inserting the magnet with bond coating into the slot of the carrier;
heating the carrier loaded with the magnet at 150° C., wherein, the foaming agent expands.

### Comparative Example 2

The method for preparing the magnet and the magnetic component comprises:
mixing the raw material to prepared the thermosetting adhesive A-1 with reference to Table 1;
applying the thermosetting adhesive A-1 on the surface of a magnet matrix, surface drying at 40° C. to obtain the first thermosetting adhesive layer, then applying the thermosetting adhesive A-1 on the first thermosetting adhesive layer, and surface drying at 40° C. to obtain the second thermosetting adhesive layer, further obtain the magnet, wherein the thickness of the first thermosetting adhesive layer is 80 μm, the thickness of the second thermosetting adhesive layer is 20 μm, so the total thickness of the thermosetting adhesive layer is 100 μm;
inserting the magnet with bond coating into the slot of the carrier;
heating the carrier loaded with the magnet at 150° C., wherein, the foaming agent expands.

In order to compare the performance of the bond coating after heated and expansion, performance tests were conducted, and the results are shown in Table 3:

Item one: 50 magnets with bond coating were stacked vertically for 48 hours.

Item two: the magnet with bond coating was placed for half a year, heated at 180° C. for 30 min, and the expansion rate (%) of the bond coating is obtained.

Item three: the magnet with bond coating is heated at 180° C. for 30 min to expand the adhesive layer, and then baked at 180° C. for 196 hours, so that the shrinkage rate of the bond coating is obtained.

Item four: inserting the magnet with bond coating into the slot of the carrier, heating at 180° C. for 30 min to expand the bond coating, and testing the peeling force (N/mm²) between the bond coating and the slot wall at room temperature.

Item five: inserting the magnet with bond coating into the slot of the carrier, heating at 180° C. for 30 min to expand the bond coating, and testing the peeling force (N/mm²) of the bond coating and the slot wall at 160° C.

Item six: neutral salt spray test (h).

Item seven: PCT (high-pressure accelerated aging life test) (h), experimental conditions: temperature 120° C., relative humidity 100%, pressure 2 atm.

TABLE 3
test results

| | Example | Example | Example | Example | Example | Example | Example | Example | Comparative | Comparative |
|---|---|---|---|---|---|---|---|---|---|---|
| | 1 | 2 | 3 | 4 | 5 | 6 | 7 | 8 | example 1 | example 2 |
| Item | No adhesion | | | | | | | | Slight | Severe |
| one | | | | | | | | | adhesion | adhesion |
| Item | 160.23 | 192.14 | 268.38 | 274.38 | 282.15 | 343.56 | 355.13 | 282.36 | 50.36 | — |
| two | | | | | | | | | | |
| Item | 4.76 | 3.85 | 2.15 | 2.85 | 2.74 | 1.56 | 1.35 | 3.62 | 80.12 | — |
| three | | | | | | | | | | |
| Item | 17.03 | 18.56 | 21.26 | 20.12 | 20.34 | 25.69 | 28.44 | 19.35 | 9.63 | — |
| four | | | | | | | | | | |
| Item | 4 | 4.2 | 5.1 | 4.3 | 4.5 | 5.3 | 6.2 | 4.5 | Direct | — |
| five | | | | | | | | | detachment | |
| Item | 200 | 200 | 200 | 200 | 200 | 200 | 200 | 200 | 60 | — |
| six | | | | | | | | | | |
| Item | 200 | 200 | 200 | 200 | 200 | 200 | 200 | 200 | 80 | — |
| seven | | | | | | | | | | |

Word Explanation:

The “stickiness” in this application refers to the property of the bond coating having the ability to prevent the magnet placed on the carrier from slipping or falling off under the influence of gravity or forces generated by assembly related operations before curing the adhesive layer.

The “expansion rate” in this application refers that with the presence of a foaming agent in the bond coating, the foaming agent expands after heating, resulting in an increase in the volume of the foaming agent. The expansion rate (%)=(thickness of the bond coating after expansion−thickness of the bond coating before expansion)/thickness of the bond coating before expansion.

The “shrinkage rate” in this application refers to the partial shrinkage of the thickness of the expanded bond coating under high temperature conditions. To test the high-temperature resistance of the expanded bond coating, the thickness change of the expanded bond coating before and after a certain high temperature condition is characterized, and the shrinkage rate (%) is (the thickness of the expanded bond coating—the thickness of the bond coating after a certain high temperature treatment)/the thickness of the expanded bond coating.

In item one of table 3, no adhesion means no adhesion between the magnets, indicating that the magnet surface is not sticky; slight adhesion means slight adhesion between magnets, indicating that the surfaces of the magnets are slightly sticky; the adhesion is severe, which means that the adhesion between magnets is severe regardless of the application, so that no subsequent test is performed.

Analysis of the test results reveals that the foaming agent is a major factor in the volume of the expanded bond coating. The bond coating obtained by applying the thermosetting adhesive layer for multiple times or repeatedly and alternately applying the thermosetting adhesive layer and the thermoplastic adhesive layer has higher expansion efficiency, and the bonding strength of the bond coating itself and the bonding strength of the bond coating with the magnet matrix and the inner wall of the slot are higher. The magnet prepared in this application is tested in the PCT experiment for 200 hours before being taken out, and there is no change in the surface bond coating of the magnet. However, after 80 hours of testing for the magnet in comparative example 1, the surface bond coating of the magnet shows bubbling phenomenon, indicating that the magnet prepared in this application has excellent high-temperature resistance and anti-corrosion performance. In addition, test results show that the adhesion between the magnet and the carrier component is excellent, the shrinkage rate of the bond coating prepared by the method is lower than 5% at 180° C., indicating the use temperature on the expansion behavior of the bond coating is low.

The embodiments of the present application are described in detail above. The principle and the embodiment of the present application are explained by applying specific examples, and the above description of the embodiments is only used to help understand the technical solution and the core idea of the present application. Therefore, a person skilled in the art should, according to the idea of the present application, change or modify the embodiments and applications of the present application based on the changes or modifications of the present application. In view of the above, the description should not be taken as limiting the application.

1. A magnet comprising:
a magnet matrix; and
a bond coating arranged at a surface of the magnet matrix and including:
a thermosetting adhesive layer including a foaming agent; and
a thermoplastic adhesive layer arranged farther away from the surface of the magnet matrix than the thermosetting adhesive layer.

2. The magnet according to claim 1, wherein:
the bond coating is one of a plurality of bond coatings of the magnet that are sequentially arranged outward from the surface of the magnet matrix;
a ratio of a thickness of the thermoplastic adhesive layer in an outermost one of the plurality of bond coatings to a thickness of the thermoplastic adhesive layer in any other one of the plurality of bond coatings is in a range from 2:1 to 8:1.

3. The magnet according to claim 2, wherein a total thickness of the plurality of bond coatings is in a range from 80 μm to 150 μm.

4. The magnet of claim 2, wherein a ratio of a sum of thicknesses of all of the thermosetting adhesive layers to a sum of thicknesses of all of the thermoplastic adhesive layers is in a range from 4:1 to 10:1.

5. The magnet according to claim 1, wherein a thickness of the bond coating is in a range from 80 μm to 150 μm.

6. The magnet of claim 1, wherein a ratio of a thickness of the thermosetting adhesive layer to a thickness of the thermoplastic adhesive layer is in a range from 4:1 to 10:1.

7. The magnet of claim 1, wherein the thermoplastic adhesive layer includes an auxiliary agent, and the auxiliary agent includes nano barium sulfate and nano ethylene wax.

8. The magnet of claim 1, wherein:
the thermosetting adhesive layer includes a hardener, a filler, and an auxiliary agent;
the hardener includes at least one of guanidine, substituted guanidine, aromatic amine, or guanamine derivative;
the filler includes at least one of silicon dioxide, calcium oxide, zinc oxide, magnesium oxide, aluminum oxide, calcium carbonate, or talcum; and
the auxiliary agent includes at least one of a curing accelerator, a coupling agent, a defoaming agent, fiber, rubber particles, a diluent, or a flame retardant.

9. A method for preparing a magnet comprising:
mixing a foaming agent into a thermosetting adhesive to serve as a raw material of a thermosetting adhesive layer; and
applying a bond coating to a surface of a magnet matrix;
wherein:
the bond coating includes the thermosetting adhesive layer and a thermoplastic adhesive layer, and the thermosetting adhesive layer is closer to the surface of the magnet matrix than the thermoplastic adhesive layer; and
the thermosetting adhesive layer is subjected to low-temperature surface drying treatment, and the thermoplastic adhesive layer is subjected to low-temperature curing treatment.

10. The method according to claim 9, wherein a thickness of the bond coating is in a range from 80 μm to 150 μm.

11. The method according to claim 9, wherein:
applying the bond coating includes applying a plurality of bond coatings to the surface of the magnet matrix; and
a ratio of a thickness of the thermoplastic adhesive layer in an outermost one of the plurality of bond coatings to a thickness of the thermoplastic adhesive layer in any other one of the plurality of bond coatings is in a range from 2:1 to 8:1.

12. The method according to claim 9, wherein a ratio of a thickness of the thermosetting adhesive layer to a thickness of the thermoplastic adhesive layer is in a range from 4:1 to 10:1.

13. The method according to claim 9, further comprising, before applying the bond coating:
mixing a monomer used for synthesizing a thermoplastic base agent, an initiator, and an auxiliary agent in distilled water as a raw material of the thermoplastic adhesive layer.

14. The method according to claim 9, wherein the thermosetting adhesive layer is formed by applying the raw material of the thermosetting adhesive layer a plurality of times.

15. The method according to claim 9, further comprising:
before mixing the foaming agent into the thermosetting adhesive, pretreating the foaming agent using a monomer used for synthesizing a thermoplastic base agent;
wherein mixing the foaming agent into the thermosetting adhesive includes mixing the pretreated foaming agent into the thermosetting adhesive as the raw material of the thermosetting adhesive layer.

16. A method for preparing a magnetic component comprising:
inserting a magnet into a slot of a carrier, the magnet including:
a magnet matrix; and
a bond coating arranged at a surface of the magnet matrix and including:
a thermosetting adhesive layer including a foaming agent; and
a thermoplastic adhesive layer arranged farther away from the surface of the magnet matrix than the thermosetting adhesive layer;
heating the carrier loaded with the magnet such that the foaming agent contained in the bond coating expands, the thermosetting adhesive layer cross-links and cures, the thermosetting adhesive layer and the thermoplastic adhesive layer co-polymerize, and the heated bond coating fills a gap between the magnet matrix and a wall of the slot of the carrier.

17. A magnetic component produced by the method according to claim 16.
